(19) United States
(12) Patent Application Publication
(10) Pub. No.: US 2008/0038412 A1
(43) Pub. Date: Feb. 14, 2008

(54) Food for Short-Headed Dogs

(76) Inventors: Aurelien Guilloteau, Aimargues (FR); Eric Servet, Aimargues (FR)

Correspondence Address: IP GROUP OF DLA PIPER US LLP, ONE LIBERTY PLACE, 1650 MARKET ST, SUITE 4900, PHILADELPHIA, PA, 19103, US

(21) Appl. No.: 11/792,986

(22) PCT Filed: Dec. 15, 2005
(86) PCT No.: PCT/EP05/56819

§ 371 Date: Aug. 1, 2007

(30) Foreign Application Priority Data
Dec. 15, 2004 (FR) 0413369

(51) Int. Cl. A23K 1/18; A23K 1/00; A23K 1/16

(52) U.S. Cl. 426/104

(57) ABSTRACT

A dry food intended for feeding dogs comprising: at least one source of animal or plant protein and/or at least one source of slow-release or rapid-release carbohydrates and/or at least one source of animal or vegetable fat, substantially in the form of a parallelepiped, wherein at least two opposed faces of the parallelepiped comprise at least one hollow portion and at least one lump portion, the hollow and lump portions on a first face lie opposite the lump and hollow portions, respectively, of the opposite face of the parallelepiped.

### RELATED APPLICATION

This is a §371 of International Application No. PCT/EP2005/056819, with an inter-national filing date of Dec. 15, 2005 (WO 2006/064042 A1, published Jun. 22, 2006), which is based on French Patent Application No. 04/13369, filed Dec. 15, 2004.

### TECHNICAL FIELD

This disclosure relates to a dry food for a dog, in the general shape of a wave so as to reduce the time taken to pick up the food and increase the time taken to chew it. The food is particularly intended for brachycephalic dogs such as Boxers or British Bulldogs.

### BACKGROUND

It is generally accepted that domesticated dogs are descended from one and the same common ancestor, namely the gray wolf (Savolainen et al., 2002) and thus have morphological characteristics of the jaws of carnivores which are evolved to catch living or dead prey, by biting it, then tearing off its flesh and chewing it.

Over the centuries, the domestication of dogs by man has been accompanied by crossing to encourage certain morphological characteristics such as the size or the coat of the dog. Hence, there are now a great many breeds of dogs some of which are very prone to bucco-dental diseases and/or difficulties in picking up and chewing which are directly related to the morphology of their jaws.

It is also well known practice for dogs to be classified according to their size, and also for canine breeds to be classified according to three distinct skull types. Hence, distinctions are made on the one hand between three broad categories of size: small breeds (1 to 10 kg), medium breeds (11 to 25 kg) and large breeds (26 to 80 kg and above) and, on the other hand, three types of skull morphology: dolichocephalic, mesocephalic and brachycephalic. In order to classify canine breeds into one of the aforementioned skull types, use is made of the cephalic index which corresponds to the width of the skull multiplied by 100 and divided by the length of the skull. Dolichocephalics which have a narrow base of the skull and a very elongate muzzle have a cephalic index of below 50. Mesochephalics, which have a base of the skull and a muzzle that are generally of equal lengths, have a cephalic index of more or less 50. Brachycephalics, on the other hand, have a short, broad and rounded skull and have a cephalic index of below 50. Brachycephalic dogs have a prognathism which is more or less pronounced according to breed. A prognathism is understood to be a forward projection of one of the two jawbones. In the brachycephalic dog category, the Boxer and the British Bulldog have an underbite, that is to say that their mandible projects forward and their maxilla is shortened.

These morphological particularities of brachycephalic dogs, apart from leading to bucco-dental problems such as gingival hyperplasia and an overlapping of milk teeth and adult teeth, breathing problems and an insufficient bite, lead also to problems with picking up and chewing food which may cause gastric and/or bucco-dental problems.

The problem is that these brachycephalic dogs have a maxilla which is shorter than the mandible, so their top and bottom incisors are unable to bite together, thus making it difficult to pick up food. In addition, brachycephalics have a maxilla which is wider than the maxilla of other dogs in the region of the premolars and molars, encouraging them to swallow food without chewing it.

The difficulty these dogs experience in picking up their food leads to stress and the lack of chewing of said food results in excessively rapid ingestion which can cause the dog to choke, and leads to digestive difficulties and bucco-dental problems.

It is well known to veterinary surgeons that excessively rapid ingestion of food can cause the formation of tartar and dental plaque which are the cause of all periodontal diseases (A. Grimberg, and Ph. Beltramo, “Recueil de Médecine Vétérinaire”, 1991, 167 (10/11), 997-1003). In order to combat the formation of tartar and dental plaque, there are several solutions that have been proposed. Examples of these can be found in Patents EP 0 575 021 and U.S. Pat. No. 5,431,927 filed by the Colgate-Palmolive company and describing a nutritionally balanced extruded food in the form of a cylinder or disk containing fibrous striations. Also known are Patents EP 0 552 897 and U.S. Pat. No. 5,296,209, again filed by the Colgate-Palmolive company and describing a chew consisting of an edible flexible cellular matrix containing a cellulose-type material and an additive.

Although these solutions are able to limit the formation of tartar and dental plaque, they are unable to solve the digestive problems caused by excessively rapid ingestion of food.

It is well known to veterinary surgeons that excessively rapid ingestion of food causes aerophagy, with a rapid accumulation of gas which distends the stomach and can lead to gastric vovulus (W. G. Guilford, “Strombeck's Small Animal Gastroenterology”, 3^{rd} Edition, W. B. Saunders Company Ed., 1996, pp 303-317). In addition, excessively rapid ingestion of food is likely to lead to gastric dilation vovulus syndrome in dogs without either the nature or the quality of food being in any way at fault (Véronique Viateau, “Recueil de Médecine Vétérinaire”, 1993, 169 (11/12), 985-997; C. F. Burrows and L. A. Ignaszewski, “Journal of Small Animal Practice”, 1990, 31, 495-501).

It could therefore be advantageous to provide a dry food the shape and size of which make it possible to reduce the time it takes to pick up the food and increase the time it takes to chew it.

In this regard it will be noted that industrially produced food for dogs can be classified into two broad categories: wet food known as loaf and dry food such as biscuits, granules, crumbs, flakes, etc. In the pet food market, it is dry food that is currently undergoing the greatest expansion.

This is because dry food offers numerous advantages over wet food. It is practical to use and easy to keep. Furthermore, it is more economical than wet food given its moisture content of less than 14% which gives 1 kg of dry food the equivalent nutritional benefit of 4 kg of wet food.

There are two broad families of dry food for dogs: monocomponent food and multicomponent food. Monocomponent food is food in which the individual components are identical and multicomponent food is food containing at least two different individual components.

### SUMMARY

We have surprisingly discovered that it is possible to reduce the time taken by a dog to pick up a food and increase the time it takes the dog to chew the food, thereby slowing the ingestion of the food, particularly in the case of brachycephalic dogs such as Boxers or British Bulldogs for example, by offering them a dry food in which one individual component is of a clearly defined shape.

We therefore provide a dry food intended for feeding dogs, of the type containing at least one source of animal or plant protein and/or at least one source of slow-release or rapid-release carbohydrates and/or at least one source of animal or vegetable fat, whether it be a monocomponent food or a multicomponent food, and which overall is substantially in the form of a parallelepiped, notable in that at least two opposite faces of the parallelepiped comprise at least one hollow portion and at least one lump portion, the hollow portion and the lump portion on a first face lying opposite the lump portion and hollow portion, respectively, of the opposite face of the parallelepiped giving the food the overall shape of a wave.

Each hollow portion may consist of a concave region, each lump portion may consist of a convex region and the radius of curvature of each concave region may differ from the radius of curvature of each convex region.

Furthermore, the dimensions of the food have an influence over how much easier it is to pick up and how much longer it takes to chew.

Thus, the parallelepiped preferably has a volume ranging between about 5000 and about 8000 m³ and dimensions of about 25 to about 35 mm×about 15 to about 25 mm×about 5 to about 11 mm.

### BRIEF DESCRIPTION OF THE DRAWINGS

Other advantages and features will become better apparent from the description which will follow of a number of aspects, given by way of nonlimiting examples, with reference to the attached drawings in which:

FIG. 1 is a perspective view of our dry food,

FIG. 2 is a view in longitudinal section of the dry food depicted in FIG. 1,

FIG. 3 is a view from above of our dry food,

FIG. 4 is a table collating biscuits of the prior art with biscuits for dogs of the Boxer breed,

FIG. 5 is a graph in the form of a bar chart representing the average time taken to pick up the various styles of biscuit listed in the table of FIG. 4,

FIG. 6 is a graph in the form of a bar chart representing the average time taken to chew the various styles of biscuit listed in the table of FIG. 4,

FIG. 7 is a graph representing the distribution of biscuit shapes with respect to the time taken to pick up and chew them,

FIG. 8 is a table classifying the style of biscuit according to decreasing time taken to pick it up and increasing time taken to chew it,

FIG. 9 is a graph representing the relationship between the surface area of the biscuits and the time taken to pick them up,

FIG. 10 is a graph representing the relationship between the volume of the biscuits and the time taken to chew them,

FIG. 11 is a table collating biscuits of the prior art and biscuits for dogs of the British Bulldog breed,

FIG. 12 is a graph in the form of a bar chart representing the average time taken to pick up the various styles of biscuit listed in the table of FIG. 11,

FIG. 13 is a graph in the form of a bar chart representing the average time taken to chew the various styles of biscuit listed in the table of FIG. 11,

FIG. 14 is a graph representing the distribution of biscuit shapes with respect to the time taken to pick up and chew them,

FIG. 15 is a table classifying the style of biscuit according to decreasing time taken to pick it up and increasing time taken to chew it,

FIG. 16 is a graph representing the relationship between the surface area of the biscuits and the time taken to pick them up, and

FIG. 17 is a graph representing the relationship between the volume of the biscuits and the time taken to chew them.

### DETAILED DESCRIPTION

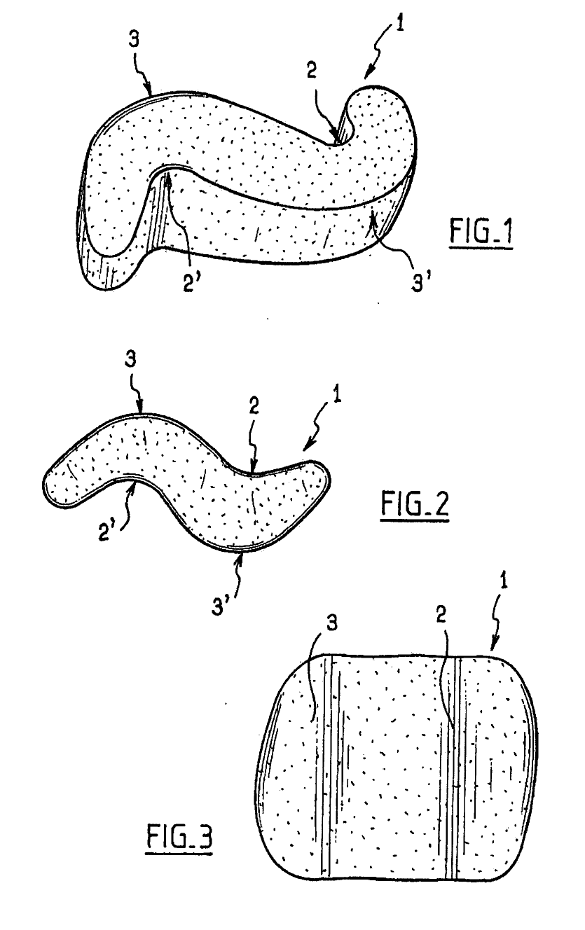

With reference to FIGS. 1 to 3, the dry food intended for feeding dogs according to the invention comprises, in the conventional way, at least one source of animal or plant protein and/or at least one source of slow-release or rapid-release carbohydrates and/or at least one source of animal or vegetable fat. It is overall in the shape of a parallelepiped 1 in which at least two opposite faces of the parallelepiped comprise at least one hollow 2 and 2′ and at least one lump 3 and 3′, said hollow 2 and said lump 3 on a first face lying opposite the lump 3′ and hollow 2′ respectively of the opposite face of the parallelepiped 1. Thus, the food has a longitudinal cross section (FIG. 2) in the shape of a wave. Each hollow 2, 2′ consists of a concave region and each lump 3, 3′ consists of a convex region, the radius of curvature of each concave region 2, 2′ differing from the radius of curvature of each convex region 3, 3′.

Quite obviously, the radius of curvature of each concave region 2, 2′ may be more or less equal to the radius of curvature of each convex region 3, 3′ without in any way departing from the scope of the invention.

Furthermore, the corners between two adjacent faces of the parallelepiped 1 are rounded so as to avoid injuring the dog in any way as the dog picks it up or chews it. The food is obtained by extruding it through a wave-shaped extrusion die.

This particular shape of food makes it possible to reduce the time it takes to pick up the food. Specifically, the overall wave shape of the food means that there is separation at least at one of its ends irrespective of the position in which it is set down on a plane. This separation at least at one of the ends of the food gives the dogs a purchase thus reducing the time taken to pick it up. Furthermore, the particular shape of the food according to the invention is also able to increase the time it takes to chew the latter. This food is particularly intended for feeding brachycephalic dogs which, because of their morphological characteristics, have difficulties with picking up and chewing which results in them taking a long time to pick up cylindrical food of the prior art and spending a short time chewing it, as will be explained a little later on.

Furthermore, we noticed that, apart from the shape of the food, the dimensions of the latter have an influence over how long it takes to pick up and how long it takes to chew. Thus, in order to obtain a time taken to pick up and a time taken to chew that are optimum for brachycephalic dogs, the parallelepiped preferably needs to have a volume ranging between about 5000 and about 8000 mm³ and/or a surface area projected onto a plane ranging between about 500 and about 700 mm² and/or dimensions of about 25 to about 35 mm×about 15 to about 25 mm×about 5 to about 11 mm.

### EXAMPLE 1

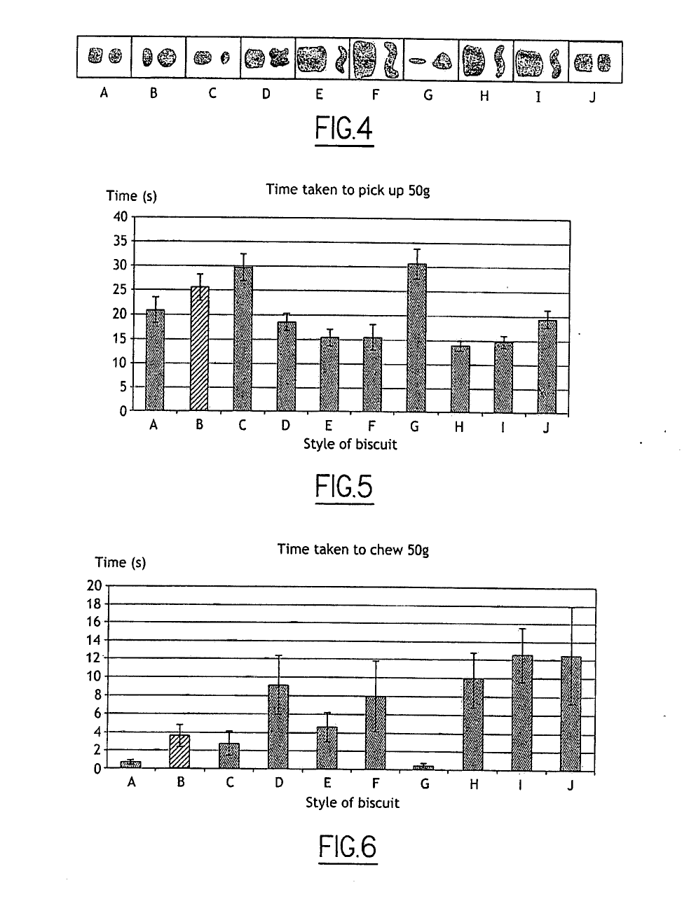

Tests were carried out on a panel of 18 Boxer dogs that were fed for several days with biscuits of the prior art (styles A, B, C, D, G and J) and wave-shaped biscuits according to the invention of different sizes (styles E, F, H and I) as indicated in the table of FIG. 4.

At the dogs' mealtimes, the time devoted to picking up and the time devoted to chewing were timed for a food quantity of 50 g. These measurements of the time taken to pick up and the time taken to chew were obtained from analyzing videos recorded during meals. These videos were shot using a parallelepipedal box the top face of which had a window on which a transparent dish, for example made of glass, filled with biscuits, was placed. A digital camera and a lighting means, such as a neon light for example, were placed in the box under the window in order to film meals from beneath. A second digital camera was advantageously positioned outside the box to film the meal from the side.

The average times taken to pick up the various styles of biscuit are recorded on the graph in the form of a bar chart in FIG. 5.

The Boxers used their tongues, their lips and their teeth to grasp the biscuits; however, tongues and lips were most used. The Boxers picked up the biscuits in bunches regardless of the shape of the biscuits.

The time taken to pick up 50 g of style B, the commonest commercially available style, was 26 s, making it one of the styles that was the hardest to pick up.

Style C, of oval overall shape, and style G, in the shape of a very flat triangle, had picking-up times of 30 and 31 s respectively. The time taken to pick up these styles C and G was markedly longer than the time taken to pick up style B.

Cylindrical style A and cubic style J took 5 to 6 s less time to pick up than style B.

Style D was a cross-shaped biscuit offering stability in the dish and several latching-on points. The time taken to pick up style D was 7 s shorter than the time taken to pick up style B.

The wave-shaped styles E, F and I generated picking-up times about 11 seconds shorter than the time taken to pick up style B. It will be observed that these wave-shaped styles E, F and I are less able to move around in the dish than the other styles.

Style H, which is also wave shaped, had the shortest picking-up time. The time taken to pick up style H (14 seconds) is half the time taken to pick up style B (26 seconds).

Thus, in terms of being picked up, styles E, F, H and I, which are wave shaped, according to the invention, are associated with the best results.

Hence, the particular shape of the food according to the invention makes it easier to pick up.

In the same way as the time taken to pick up the foods was analyzed, a comparison was made between the various styles of biscuit in respect of the time taken to chew them.

The average times taken to chew the various styles of biscuit are recorded in the graph in the form of a bar chart in FIG. 6.

Biscuit style B known as the standard style took a very short time to chew at 4 s.

The triangular style of biscuit G and the cylindrical style A were associated with the shortest chewing times, of less than 1 second.

The oval style C took three seconds longer to chew than styles G and A but nevertheless took less time to chew than biscuit style B.

Cross-shaped style D took 9 seconds longer to chew than the standard biscuit style B.

The wave-shaped style of biscuit E increased the chewing time by just one second over the time taken to chew the standard style of biscuit B.

The cube-shaped style of biscuit J took a long time to chew at 13 seconds, which is 9 seconds longer than it took to chew the standard style of biscuit B. However, it will be recalled that this style of biscuit J took an extremely long time of 20 seconds to pick up.

The wave-shaped style of biscuit F, which was the longest of all the styles and had the most pronounced waviness, took 8 seconds to chew, which is four seconds longer than the standard style of biscuit B.

The wave-shaped style of biscuit H, the length, width and thickness in cross section of which were smaller than those of the wave-shaped biscuit style F, took 10 seconds to chew, which is six seconds longer than the standard style of biscuit B.

Finally, biscuit style I, which was also wave shaped, the cross-sectional length of which was the longest of the wave-shaped biscuit styles E, F, H and I according to the invention, ranging between 28 mm and 29 mm, took the longest time to chew at 13 seconds, which was equal to the time taken to chew the cubic style J, namely 9 seconds longer than the time taken to chew the standard style of biscuit B.

It would therefore seem that the particular shape of the biscuits E, F, H and I according to the invention has an impact on the time taken to chew them.

For efficient ingestion of food, the styles of biscuit need to take a short time to pick up and a long time to chew.

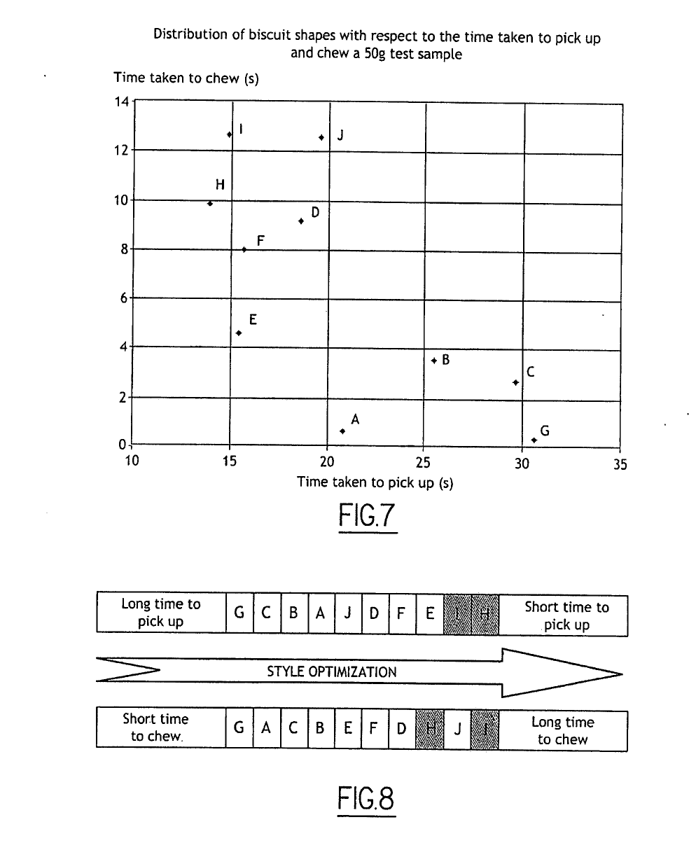

In the light of the graph in FIG. 7, which represents the distribution of biscuit shapes with respect to the time taken to pick up and chew them, and the table of FIG. 8 which classifies the styles of biscuit according to decreasing time taken to pick them up, on the one hand, and increasing time taken to chew them, on the other hand, it would seem that the wave-shaped biscuit styles H and I according to the invention afford the best results because they take a short time to pick up and a long time to chew. Nonetheless, biscuit style I has a few difficulties associated with its dimensions for manufacture, unlike style H which will therefore be the preferred one adopted.

Next, this style of biscuit H was tested over a prolonged period on the panel of 18 Boxer dogs and no weariness and no starting to choke was observed.

We have seen that the shape of the biscuit has an impact on the time taken to pick up and chew the biscuits; however, in the case of wave-shaped biscuits according to the invention, the dimensions of these biscuits also have an impact on the time it takes to pick up and chew them.

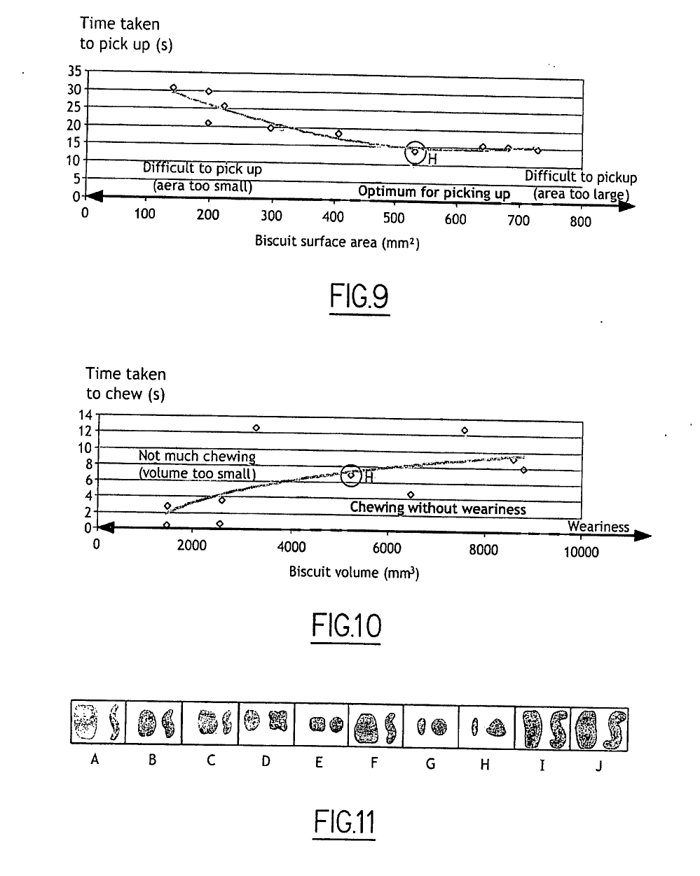

Thus, as can be seen from the graphs of FIGS. 9 and 10 which represent the relationship between the surface area of the biscuits and the time taken to pick them up, and the relationship between the volume of the biscuits and the time taken to chew them, respectively, the best results were obtained for biscuits of a volume ranging between about 5000 and about 8000 mm³, and more specifically for biscuits with dimensions of about 25 to about 35 mm×about 15 to about 25 mm×about 5 to about 11 mm. That corresponds to a biscuit with a surface area projected onto a plane ranging between about 500 and about 700 mm².

### EXAMPLE 2

Tests were carried out on a panel of 27 British Bulldogs that were fed for several days with biscuits of the prior art (styles D, E, G and H) and wave-shaped biscuits according to the invention of different sizes (styles A, B, C, F and I) as indicated in the table of FIG. 11.

Just as in example 1, the time devoted to picking up the food and the time devoted to chewing it were timed during meals when a 50 g quantity of food was offered to the dogs.

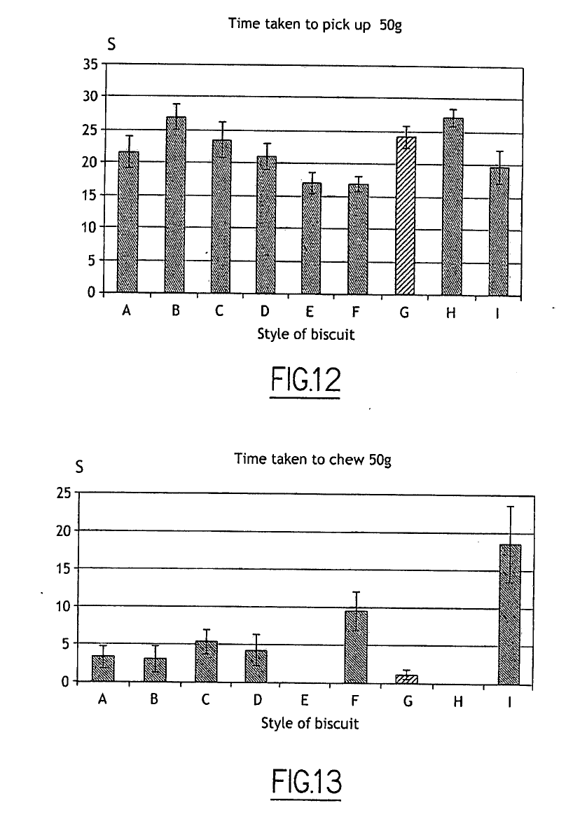

The average times taken to pick up the various styles of biscuit are recorded on the graph in the form of a bar chart in FIG. 12.

The biscuit style G, said to be the standard style, took a relatively long 24 seconds to pick up.

The time taken to pick up biscuit styles H and B was 3 seconds longer than it took to pick up the standard style of biscuit G. Biscuit style H was a very flat triangular biscuit and biscuit style B was wave shaped according to the invention, of a small size and with not very pronounced waviness.

Biscuit style C was also wave shaped according to the invention, and wider than biscuit style B. The time taken to pick up biscuit style C was 4 s shorter than it took to pick up the standard biscuit style G.

The wave-shaped style of biscuit A was 2 seconds faster to pick up than the standard style of biscuit G.

The cross-shaped style of biscuit D took a similar time to pick up to biscuit style A, and more specifically took 3 seconds less to pick up than the standard style of biscuit G.

Biscuit style I was also wave shaped and had a greater thickness and more pronounced waviness than the other styles of biscuit A, B, C and F. The time taken to pick up this style of biscuit I was 5 seconds shorter than it took to pick up the standard style of biscuit G.

Biscuit style E was a biscuit of cylindrical shape and was 7 seconds quicker to pick up than the standard style of biscuit G. However, it will be observed that this style of biscuit E rolls around in the dish and many biscuits are spilled out of the dish when the dog attempts to grasp the biscuits.

Biscuit style F, which was also wave shaped, took one of the shortest times to pick up. Specifically, the time taken to pick up this style of biscuit F was seven seconds shorter than it took to pick up the standard style of biscuit G, without biscuits being spilled from the dish, unlike the case of the cylindrical style of biscuit E.

Hence, it would seem that, of all the styles tested, it is the wave-shaped style of biscuit F according to the invention that takes the shortest amount of time to pick up.

In the same way as the time taken to pick up the foods was analyzed, a comparison was made between the various styles of biscuit in respect of the time taken to chew them.

The average times taken to chew the various styles of biscuit are recorded in the graph in the form of a bar chart in FIG. 13.

It would seem that the standard style of biscuit G is not chewed very much. Indeed, for these standard biscuits G, just one second is spent chewing 50 g of biscuits.

Biscuit styles E and H, which corresponded to cylindrical and triangular biscuits respectively, were not chewed at all. These styles of biscuit were ingested as soon as they were picked up.

The wave-shaped styles of biscuit A and B took 3 seconds to chew, that is to say 3 times longer than was spent chewing the standard style of biscuit G.

The cross-shaped style of biscuit D took 4 seconds longer to chew than the standard style of biscuit G.

The time taken to chew the style of biscuit C, which was also wave shaped, was 5 seconds longer than it took to chew the standard style of biscuit G.

The wave-shaped style of biscuit F took 8 seconds to chew.

Finally, the style of biscuit I took about 18 seconds to chew, namely 18 times longer than the standard style of biscuit G. The volume of this style of biscuit I was the largest of the styles tested and the waviness of the wave was the most pronounced.

Hence, in British Bulldogs, it would seem that the particular shape of the biscuits A, B, C, F and I according to the invention has an impact on the time taken to chew them.

For efficient ingestion of food, the styles of biscuit need to take a short time to pick up and a long time to chew.

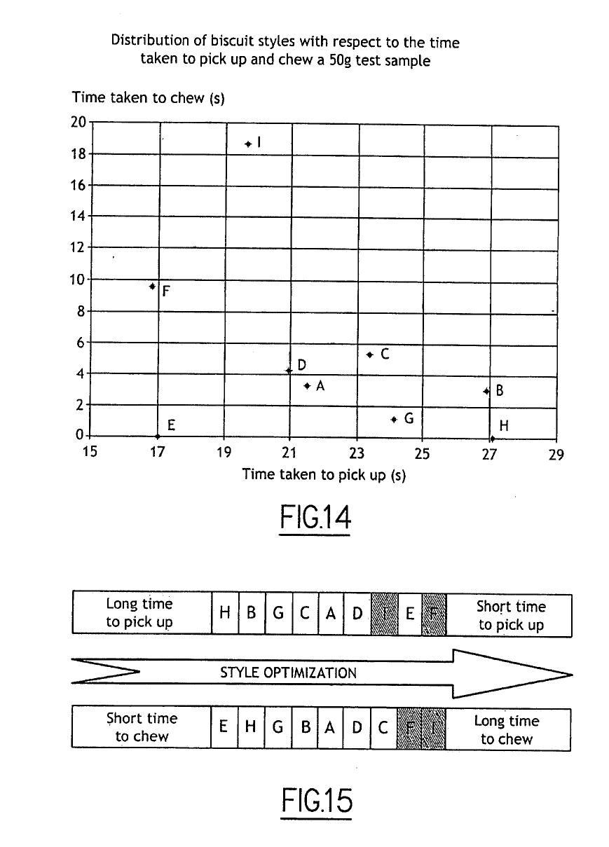

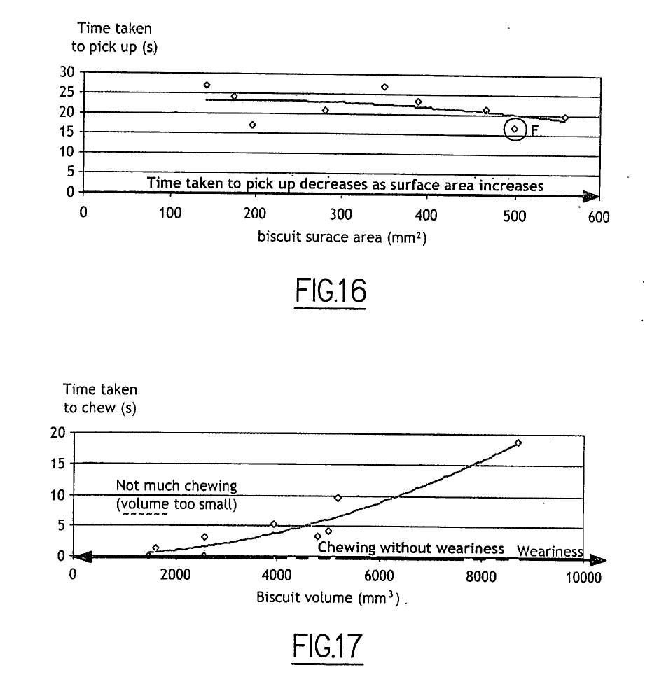

In the light of the graph in FIG. 14, which represents the distribution of biscuit shapes with respect to the time taken to pick up and chew them, and the table of FIG. 15 which classifies the styles of biscuit according to decreasing time taken to pick them up, on the one hand, and increasing time taken to chew them, on the other hand, it would seem that the wave-shaped styles of biscuit F and I according to the invention afford the best results because they take a short time to pick up and a long time to chew.

Next, these styles of biscuit F and I were tested over a prolonged period on the panel of 27 British Bulldogs.

Long-term consumption of biscuit style I demonstrated a degree of weariness probably due to the size of this style of biscuit which made it difficult to chew.

Biscuit style F seems to be the most suitable, on completion of the long-term tests, even though four dogs displayed a degree of weariness and were no longer finishing their ration of biscuit.

We have seen that the shape of the biscuit has an impact on the time taken to pick up and chew the biscuits; however, in the case of wave-shaped biscuits according to the invention, the dimensions of these biscuits also have an impact on the time it takes to pick up and chew them.

Thus, as can be seen from the graphs of FIGS. 16 and 17 which represent the relationship between the surface area of the biscuits and the time taken to pick them up, and the relationship between the volume of the biscuits and the time taken to chew them, respectively, the best results were obtained for biscuits with a volume ranging between about 5000 and about 8000 mm³, and more specifically for biscuits with dimensions of about 25 to about 35 mm×about 15 to about 25 mm×about 5 to about 11 mm. That corresponds to a biscuit with a surface area projected onto a plane ranging between about 500 and about 700 mm².

1-9. (canceled)

10. A dry food intended for feeding dogs comprising:
at least one source of animal or plant protein and/or
at least one source of slow-release or rapid-release carbohydrates and/or
at least one source of animal or vegetable fat, substantially in the form of a parallelepiped, wherein at least two opposed faces of the parallelepiped comprise at least one hollow portion and at least one lump portion, the hollow and lump portions on a first face lie opposite the lump and hollow portions, respectively, of the opposite face of the parallelepiped.

11. The food as claimed in claim 10, wherein each hollow portion consists of a concave region.

12. The food as claimed in claim 10, wherein each lump portion consists of a convex region.

13. The food as claimed in claim 10, wherein each lump portion is a convex region and each hollow portion is a concave region.

14. The food as claimed in claim 13, wherein a radius of curvature of each concave region differs from a radius of curvature of each convex region.

15. The food as claimed in claim 10, wherein corners between two adjacent faces of the parallelepiped are rounded.

16. The food as claimed in claim 10, having a projected surface area ranging between about 500 and about 700 mm².

17. The food as claimed in claim 10, wherein the parallelepiped has a volume ranging between about 5000 and about 8000 mm³.

18. The food as claimed in claim 10, wherein the parallelepiped has dimensions of about 25 to about 35 mm×about 15 to about 25 mm×about 5 to about 11 mm.

19. The food as claimed in claim 10, adapted to feed brachycephalic dogs.
